(19) United States
(12) Patent Application Publication
(10) Pub. No.: US 2025/0329931 A1
(43) Pub. Date: Oct. 23, 2025

(54) ANTENNA ELEMENT HAVING A PLURALITY OF RADIATOR PATCHES

(71) Applicant: Cambium Networks Ltd, Ashburton (GB)

(72) Inventors: Deepu Vasudevan Nair, Bangalore (IN); Jomon Thomas, Bangalore (IN); Nigel Jonathan Richard King, Ashburton (GB)

(73) Assignee: Cambium Networks Ltd, Ashburton (GB)

(21) Appl. No.: 19/178,268

(22) Filed: Apr. 14, 2025

(30) Foreign Application Priority Data
Apr. 22, 2024 (IN) 202421031758

(51) Int. Cl. H01Q 9/04; H01Q 5/10; H01Q 5/50

(52) U.S. Cl. CPC H01Q 9/0414; H01Q 5/10; H01Q 5/50; H01Q 9/0485

(57) ABSTRACT

An antenna element comprises a planar conductive reflector plate, a first planar substrate carrying a ground plane having a slot and a feed track crossing in the slot, a plurality of further planar substrates, each carrying a respective radiator patch having a shape that has the same proportions as each other radiator patch and a width which is different from each other radiator patch, and a planar non-conductive cover. The planar conductive reflector plate, the first planar substrate, the plurality of further planar substrates, and the planar non-conductive cover are disposed as successive parallel layers. The separation between successive radiator patches is less than 0.1 wavelengths at an operating frequency of the antenna element and a separation between the radiator patch closest to the planar non-conductive cover and the planar non-conductive cover is less than 0.25 wavelengths at an operating frequency of the antenna element.

### CROSS-REFERENCE TO RELATED APPLICATION

This application claims priority to India Patent Application No. 202421031758, filed on Apr. 22, 2024, the entirety of which is hereby fully incorporated by reference herein.

### TECHNICAL FIELD

The present disclosure relates generally to an antenna element having a plurality of radiator patches, and in particular, but not exclusively, to a slot-fed antenna element having a plurality of radiator patches each having a different width, configured to give a broad frequency response.

### BACKGROUND

Modern wireless communication networks are typically placed under great demands to provide high data capacity within the constraints of the allocated signal frequency spectrum. To achieve a high data capacity, it is beneficial to transmit and receive signals over a broad frequency band at high signal to noise ratio. An antenna element may be used either as a single element or as part of an array of antenna elements, for example for use in Multiple Input Multiple Output (MIMO) communication systems, for transmission and/or reception of radio signals. An antenna element may comprise a radiator patch, which typically comprises a planar metallic layer, for example having a square or rectangular shape, arranged over a ground plane. Signals may be connected to and from the patch by signal tracks connected to one or more edges of the patch or coupled to the patch through one or more slots in the ground plane, for example. However, the bandwidth over which the antenna operates effectively may be limited, limiting the frequency band over which signals may be transmitted and/or received effectively.

It would be beneficial to provide an antenna element having effective operation over a broad frequency band.

### SUMMARY

In accordance with a first aspect of the present disclosure there is provided an antenna element comprising: a planar conductive reflector plate; a first planar substrate carrying a ground plane comprising a slot on a first side, and comprising a feed track on a second side, the feed track being configured to cross the slot; a plurality of further planar substrates, each carrying a respective radiator patch, each radiator patch having a shape that has the same proportions as each other radiator patch and a width which is different from each other radiator patch; and a planar non-conductive cover, wherein the planar conductive reflector plate, the first planar substrate, the plurality of further planar substrates, and the planar non-conductive cover are disposed as successive parallel layers, wherein a separation between successive radiator patches is less than 0.1 wavelengths at an operating frequency of the antenna element and a separation between the radiator patch closest to the planar non-conductive cover and the planar non-conductive cover is less than 0.25 wavelengths at an operating frequency of the antenna element.

This structure allows the antenna element to be configured for good broad band performance. In particular, the arrangement of radiator patches having different widths, the layers being separated by less than 0.1 wavelengths, and the arrangement of the non-conductive cover and the reflector plate as disclosed allows the impedance match of the antenna element to be maintained over a broad frequency range. The width of each radiator patch may be configured to provide each radiator patch with a different respective resonant frequency within an operating frequency band of the antenna element, and the slot may be arranged to provide a respective resonant frequency within an operating band of the antenna element, different from the respective resonant frequencies provided by the plurality of radiator patches. By arranging for the radiator patches and the slot to have different resonant frequencies within the operating frequency band of the antenna element, a broad impedance match may be arranged between a feed track connected to the antenna element and the radiator patches. A broad impedance match is beneficial in increasing the operating frequency band of the antenna element and maintaining good broad band gain performance for the antenna element.

In an example, the resonant frequency provided by the slot is arranged to be lower than the respective resonant frequencies provided by the plurality of radiator patches. This has been found to be beneficial in proving a broad impedance match.

In an example, a resonant frequency provided by one of the radiator patches is higher than a resonant frequency provided by the slot by a factor of at least 30%, and in an example by a factor of at least 40%. This has been found to be beneficial in allowing a broad band impedance match while allowing broad band antenna gain performance.

In an example, a separation between the planar conductive reflector plate and the first planar substrate is 0.25 wavelengths at the first operating frequency of the antenna element. This may contribute to the resonance performance of the slot.

In an example, the slot provides a first resonant frequency and the plurality of further planar substrates comprises a first further planar substrate comprising a first radiator patch providing a second resonant frequency and a second further planar substrate comprising a second radiator patch providing a third resonant frequency, and the width of the first radiator patch at the second resonant frequency is the same proportion of a wavelength as is the width of the second radiator patch at the third resonant frequency.

In an example, the width of the first radiator patch at the second resonant frequency and the width of the second radiator patch at the third resonant frequency is between 0.6 and 0.7 of a wavelength in the dielectric medium of the first and second planar substrates, and the separation between the first and second radiator patches is 0.05 of a wavelength at the second resonant frequency. In an example, the slot has a length of between 0.3 and 0.4 wavelengths in the dielectric medium of the first planar substrate. This has been found to give good impedance matching performance. In an example, the dielectric medium of the first and second planar substrates has a dielectric constant of 4.2 and the dielectric medium of the first planar substrate has a dielectric constant of 3.5. There may be another slot provided for coupling to the radiator patches to provide radiation at an orthogonal polarisation to that provided by the first slot. The second slot may be arranged to have a different width than that of the first slot, to provide a similar resonant frequency, due to the need to offset the slots from the centre of the patch radiator because of the constraints of the two dimensional layout of the slots which do not cross each other.

In an example, the separation between the second radiator patch and the planar non-conductive cover is 0.2 of a wavelength at the second resonant frequency, the second radiator patch being closer to the planar non-conductive cover than is the first radiator patch.

In an example, the first, second and third planar substrates are formed as layers of a multi-layer circuit board, in which, for example, the separation between the first and second radiator patches and the separation between the first radiator patch and the first planar substrate is less than 0.02 of a wavelength at the second resonant frequency. This provides a compact and easily manufactured antenna element.

In an example, the separation between the second radiator patch and the planar non-conductive cover is less than or equal to 0.05 wavelengths at the second resonant frequency. This provides for a compact implementation and interaction between the radiator patches and the non-conductive cover may be used to affect the resonant frequency of the patches.

In an example, the second radiator patch is in contact with the planar non-conductive cover. This provides for a particularly compact and robust implementation.

In an example, there may be a third planar substrate providing a third radiator patch. The third radiator patch may have a different resonant frequency than the other two radiator patches, which may be used to further improve the impedance match over an operating frequency band.

In an example, the shape of each radiator patch is a square, and in another example, a hexagon.

Further features of the present disclosure will be apparent from the following description of preferred embodiments, which are given by way of example only.

### BRIEF DESCRIPTION OF THE DRAWINGS

FIG. 1 is a schematic diagram illustrating an example of an antenna element according to this disclosure. In the example shown, the antenna element has two radiator patches of different sizes.

FIG. 2 is an oblique exploded view illustrating an example of an antenna element according to this disclosure;

FIG. 3 is an oblique view illustrating a ground plane having two slots, for vertical and horizontal polarisation respectively, each slot being crossed by a respective feed track for that polarisation. The planar substrate carrying the ground plane and the feed tracks is not shown, for clarity;

FIG. 4 is a graph showing scattering parameters for an antenna element having two patch radiators as illustrated by FIGS. 1, 2 and 3. The S11 curve represents the input return loss for an input to a feed track for the antenna element, showing that return loss is maintained at less than −10 dB over a broad frequency band. Resonances of a slot and each radiator patch are visible as providing dips in the curve providing particularly good return loss;

FIG. 5 is a schematic diagram illustrating an antenna element according this disclosure having three patch radiators;

FIG. 6 is an oblique exploded view illustrating the antenna element having three patch radiators;

FIG. 7 is a graph showing scattering parameters for an antenna element having three patch radiators as illustrated by FIGS. 5 and 6;

FIG. 8 is an exploded view of an antenna element having octagonal patch radiators, the first second and third planar substrates being formed as layers of a printed circuit board; and

FIG. 9 is schematic diagram illustrating an antenna element having three patch radiators, the top patch radiator being printed on the non-conductive cover.

### DETAILED DESCRIPTION

By way of example, embodiments of the present disclosure will now be described in the context of an antenna element for operation in frequency band in the region of 4-8 GHz, and in particular for a band of 4.9-7.2 GHz, but it will be understood that embodiments of the present disclosure are not restricted to operation in this frequency or frequency range, and that antenna elements according to this disclosure may be designed to operate at higher or lower frequencies. Example antenna elements having two and three radiator patches are described, and feed tracks are provided to couple signals from and to a radio transceiver to the radiator patches to provide radiation and/or reception of signals at two orthogonal polarisations. It will be understood that other examples may be provided having more than three radiator patches, and/or may provide for radiation and/or reception of signals on a single polarisation within the scope of this disclosure. Furthermore, an antenna element according to this disclosure may be disposed as part of an array of antenna elements or as a single unit.

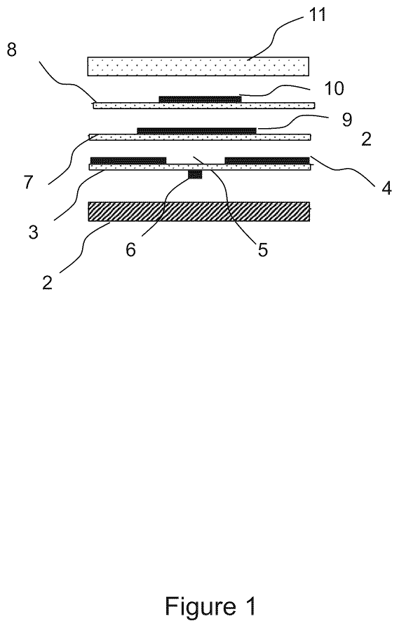

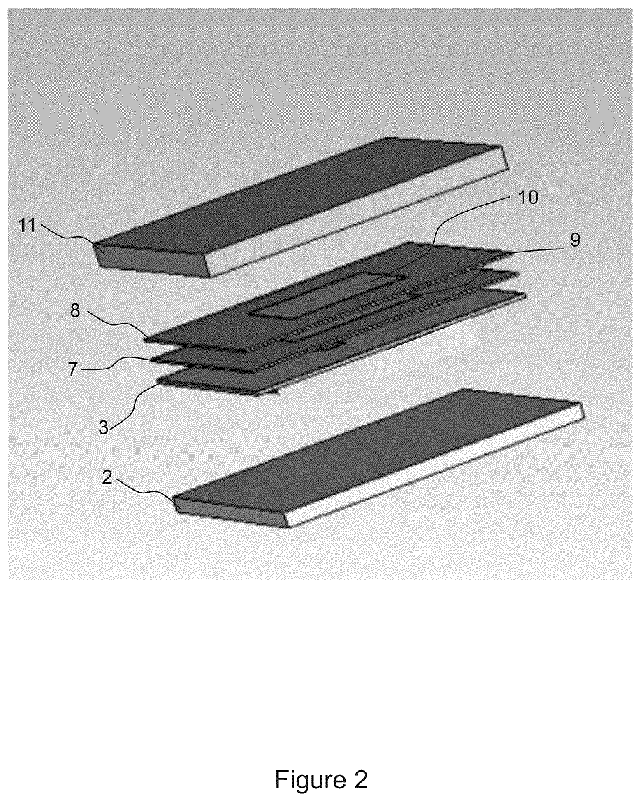

FIG. 1 is a schematic diagram (not to scale) illustrating an example of an antenna element according to this disclosure, having two radiator patches 9, 10, and FIG. 2 is an oblique exploded view illustrating the example. As may be seen, the antenna element is composed of a stack of number of layers. Radiation is transmitted and/or received from the top of the antenna element as drawn in FIG. 1, through a planar non-conductive cover 11, which provides environmental protection for the antenna patch. The planar electrically non-conductive cover may be composed, for example, of polycarbonate, or another material such as a composite or plastic material and allows the transmission of radio frequency signals without significant attenuation. The material of which the non-conductive cover is composed will have a dielectric constant, for example in the range 2.8-3.4, which may affect the resonant frequencies of the other components of the antenna element, in particular the radiator patches. This is particularly the case if the non-conductive cover is closely spaced to or touching the top radiator patch. Therefore, the presence of the non-conductive cover may influence the size requirement for the patches, in order to provide for appropriate spacing of resonant frequencies throughout an intended band to provide a broadband impedance match.

If the antenna element is one of several antenna elements forming an array of antenna elements, the non-conductive cover may be part of an overall cover protecting the whole of the array of antenna elements.

On the opposite side of the antenna element to the non-conductive cover is a planar conductive reflector plate 2, which is on the back of the antenna patch. This is typically metallic, and may, for example, be an aluminium plate. Similarly to the other layers of the antenna element construction, the planar conductive reflector plate may extend across an array of similar antenna elements, if the antenna element forms part of an antenna array. The planar conductive reflector plate 2 impedes radiation from the back of the antenna element and improves aperture coupling from a feed track to the radiator patches.

Above the planar conductive reflector plate 2, towards the radiating side of the antenna patch, is a first planar substrate 3 carrying a ground plane 4 comprising a slot 5 on a first side, and comprising a feed track 6 on a second side, configured to cross the slot 5. The first planar substrate 3 is typically composed of a printed circuit board material, for example having a dielectric constant of, for example 3.4, at an operating frequency of the antenna element. The first planar substrate, in an example, is spaced by a quarter of a wavelength from the planar conductive reflector plate 2 at an operating frequency of the antenna element. This provides for effective aperture coupling between the feed track and the radiator patches through the slot. The coupling through the slot will have a resonance, which is affected by the spacing of the conductive reflector plate 2 from the slot and by the dimensions of the slot. According to this disclosure, the frequency of this resonance is arranged to be different from the resonances of the radiator patches, so that the resonances are spread over an intended operating frequency band of the antenna patch according to this disclosure, to give a broadband frequency match from the feed track or tracks to the radiator patches.

The feed track may couple radio frequency signals to and/or from a radio transceiver to the antenna element. The feed track may be a microstrip track of nominally 50 Ohm impedance, for example. A microstrip track is a strip of copper, typically formed as an etched elongate shape on a copper-clad printed circuit board layer, the other side of the printed circuit board layer being a ground plane, typically connected to radiofrequency ground and providing a ground reference for radio frequency signals.

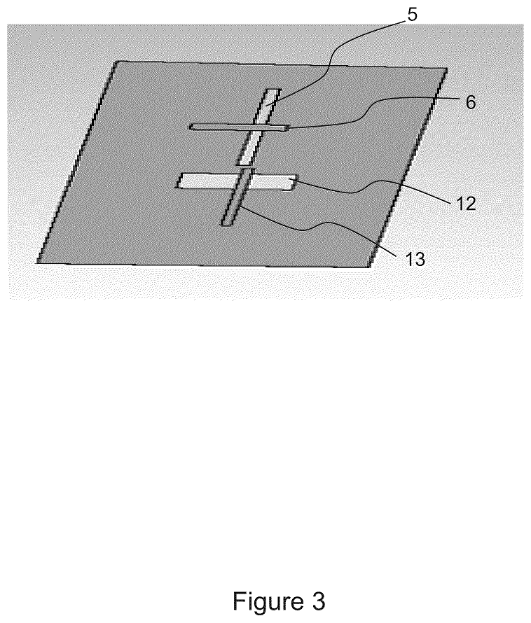

FIG. 3 is an oblique view illustrating the conductive components of the first planar substrate 3, showing the ground plane, in this example having two slots 5, 12, for vertical and horizontal polarisations, each slot being crossed by a respective feed track 6, 13, for that polarisation. The planar substrate carrying the ground plane and the feed tracks is not shown, for clarity. The view in FIG. 3 is from the bottom side, showing the feed tracks 6, 13, overlying the slots 5, 12. Only the end sections of the feed tracks crossing the respective slot are shown. The end sections are typically connected to a transceiver, some distance outside the antenna patch, by a continuance of each feed track (not shown in FIG. 3). If the antenna element is deployed as part of an array of antenna elements, the feed tracks from several antenna elements may be connected in a tree structure back to a single radiofrequency port of a transceiver. The ground plane in which the slots 5, 12 are formed, may extend beyond the antenna patch, and may extend the length and width of an array of antenna elements.

In the example shown in FIG. 3, the slot 5, 12 is an elongate rectangle in shape, having a length that determines its operating frequency range, at which the slot effectively couples a radiofrequency signal from a track crossing the slot to one or more antenna patches on the other side of the slot. It has been found that a slot having a length of between 0.3 and 0.4 wavelengths in the dielectric medium of the first planar substrate gives effective coupling, in an example. The width of the slot is less critical, and an optimum length and width may be determined by modelling using a radio frequency simulation package, for example. Each feed track has a short section that continues beyond the slot before the end of the track, which may be referred to as a radio frequency stub. The length of the stub may be adjusted, for example using a radio frequency modelling package and/or by experimentation, to produce a good impedance match for the end of the feed track.

In an example of signal flow for a transmitted signal, a radiofrequency signal, in this case occupying some or all of a band 4.9-7.2 GHz, is generated in a radio transceiver, and transmitted via a microstrip feed track to the antenna element. The feed track 6 crosses a slot 5, and ends a short distance beyond the slot 5. The radiofrequency signal is coupled through the slot 5 in the ground plane to a radiator patch 9 above the slot, “above” in this case meaning in a direction towards the radiating side of the antenna element. The radiofrequency signals are also coupled to a second radiator patch 10, above the first radiator patch 9. The combination of the first radiator patch and the second radiator patch cause radiation through the non-conductive cover. The radiator patches are, in this example, squares of copper carried by a substrate that is made of printed circuit board material. The dimensions and spacings are arranged as described, in order to give a broad band impedance match into the antenna element. In particular, the sizes of the patches and the length of the slot are arranged to give respective resonances distributed across the intended frequency band to give a broadband impedance match at the input, to give efficient transmission of radiofrequency signals in terms of gain flatness over the intended frequency band.

Returning to FIGS. 1 and 2, above first planar substrate 3, towards the radiating side of the antenna patch, are shown the further planar substrates 7, 8, each carrying a respective radiator patch 9, 10. The further planar substrates 7, 8 may be composed of a printed circuit board material, such as an epoxy-glass composite, for example having a dielectric constant of 4.2, at an operating frequency of the antenna element. Each substrate layer may extend across an array of similar antenna elements, if the antenna element forms part of an antenna array. The planar substrates are electrically non-conductive, an allow transmission of radio frequency signals through them. The provide a support for the conductive elements, such as the feed tracks, ground plane, and radiator patches carried by them. The conductive elements are typically formed by etching of copper layers attached to the substrates. The substrate layers may be individually formed, and spaced apart by suitable mechanical supports, typically at the edges of the antenna elements, or the substrate layers may form layers of a multi-layer printed circuit board, in which they are bonded together with intermediate layers of printed circuit board material to provide the requisite spacing between the conductive components.

In the example illustrated in the FIGS. 1 and 2 there are two planar substrates 7, 8, each with a radiator patch 9, 10, but in other examples 3 or more planar substrates and radiator patches may be provided, arranged in a stack of patches, one above the other. Each radiator patch has a shape that has the same proportions as each other radiator patch, in the example illustrated each radiator patch is a square, and a width which is different from each other radiator patch. In the example illustrated, the radiator patch 10 furthest from the conductive reflector plate 2 has a smaller width than the radiator patch 9 closer to the reflector plate 2.

In examples, the separation between successive radiator patches on different layers is less than 0.1 wavelengths at an operating frequency of the antenna element and a separation between the radiator patch closest to the planar non-conductive cover and the planar non-conductive cover is less than 0.25 wavelengths at an operating frequency of the antenna element. In the example illustrated by FIGS. 1, 2 and 3, the separation between successive radiator patches on different layers is 0.05 wavelengths, and the separation between the radiator patch closest to the planar non-conductive cover and the planar non-conductive cover is 0.2 wavelengths at an operating frequency of the antenna element, in this example at 6.5 GHz. In an alternative example, the patch radiator closest to the non-conductive cover may be in contact with the non-conductive cover. The width of the top radiator patch in this example is 0.64 wavelengths the resonant frequency of the top patch of 7.1 GHz, and the width of the bottom radiator patch in this example is 0.64 wavelengths the resonant frequency of the bottom patch of 6.4 GHz. It can be seen that in this example the width of the first radiator patch at its resonant frequency is the same proportion of a wavelength as is the width of the second radiator patch at its respective resonant frequency. It has been found that a width of 0.6-0.7 wavelengths in the dielectric medium of the planar substrate at the respective resonant frequency may give good performance. The width of each radiator patch is arranged to provide each radiator patch with a different respective resonant frequency within an operating frequency band of the antenna element, and the slot may be arranged to provide a respective resonant frequency within an operating band of the antenna element, different from the respective resonant frequencies provided by the plurality of radiator patches. By arranging for the radiator patches and the slot to have different resonant frequencies within the operating frequency band of the antenna element, a broad impedance match may be arranged between a feed track connected to the antenna element and the radiator patches. A broad impedance match is beneficial in increasing the operating frequency band of the antenna element and maintaining good broad band gain performance for the antenna element.

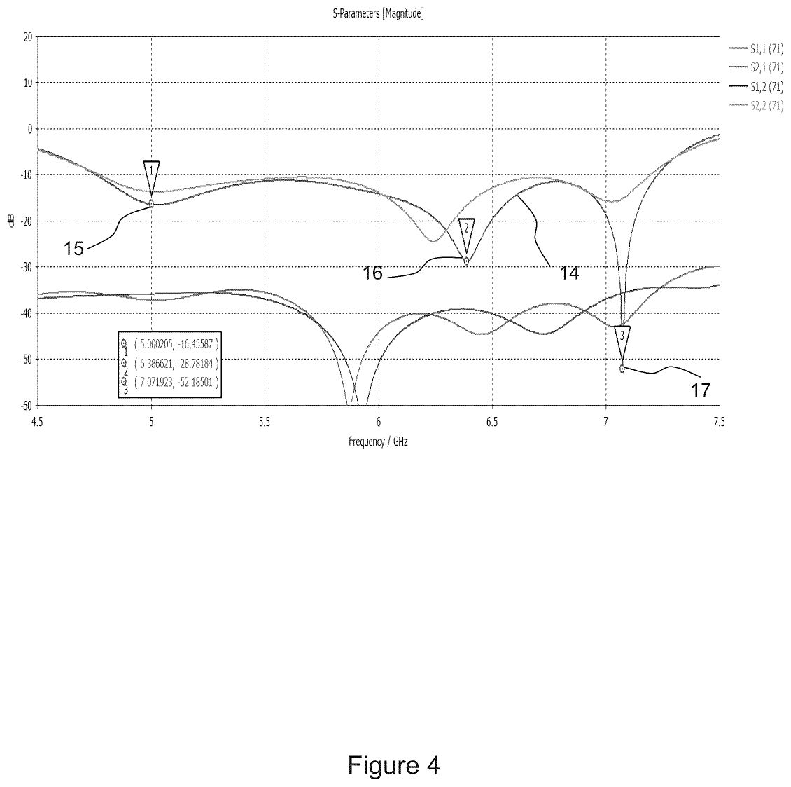

FIG. 4 is a graph showing scattering parameters for the antenna element having two patch radiators as illustrated by FIGS. 1, 2 and 3. The S11 curve 14 represents the input return loss for an input to a feed track for the antenna element, showing that return loss is maintained at less than −10 dB over a broad frequency band. The resonance of a slot 15 and the resonance of each radiator patch 16, 17 are visible as providing dips in the curve 14 providing particularly good return loss. It can be seen that by distributing the resonances at different frequencies across an intended operating band, in this case approximately 4.9-7.2 GHz, a good return loss may be achieved across the band. The return loss represents signal power reflected from an impedance mismatch at a connection to the device under test, in this case a connection to the feed tracks for the respective polarisation feeds. A low return loss shows that the impedance match is good, so that power is transferred efficiently to and from the radiating parts of the antenna element. The S22 curve shows the return loss for a port for an orthogonal polarisation from the port used for the S11 measurement. S21 and S12 represent isolation between polarisation ports, which is shown to be good.

In this example, the resonant frequency 15 provided by the slot is arranged to be lower than the respective resonant frequencies 16, 17 provided by the plurality of radiator patches. This has been found to be beneficial in proving a broad impedance match. In this example, a resonant frequency 17 provided by one of the radiator patches is higher than a resonant frequency 15 provided by the slot by a factor of 41%. This provides for a very good broadband performance.

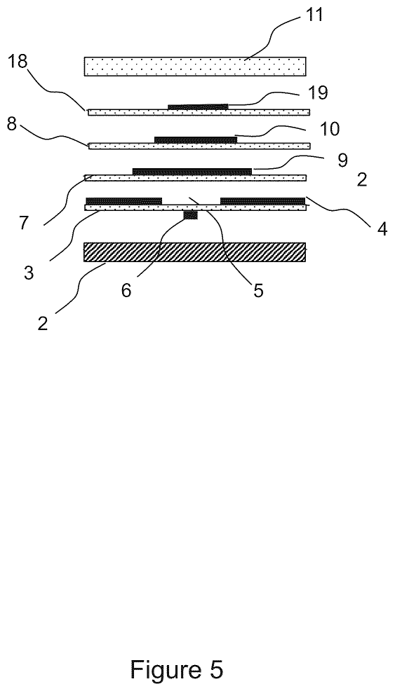

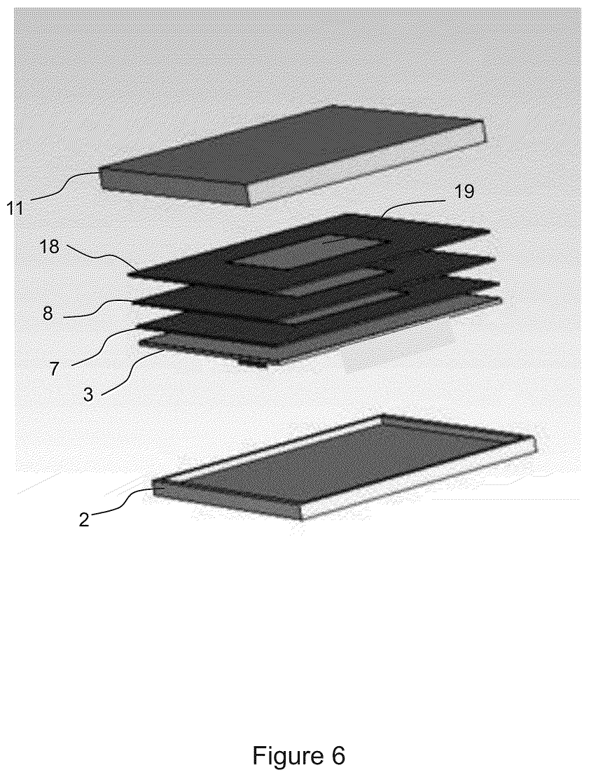

FIG. 5 is a schematic diagram illustrating an antenna element according this disclosure having three patch radiators and FIG. 6 is an oblique exploded view illustrating the antenna element having three patch radiators. Construction of this example is similar to that illustrated by FIGS. 1, 2 and 3 except that a third planar substrate 18 provides a third radiator patch 19. The third radiator patch has a different resonant frequency than the other two radiator patches, which may be used to further improve the impedance match over an operating frequency band.

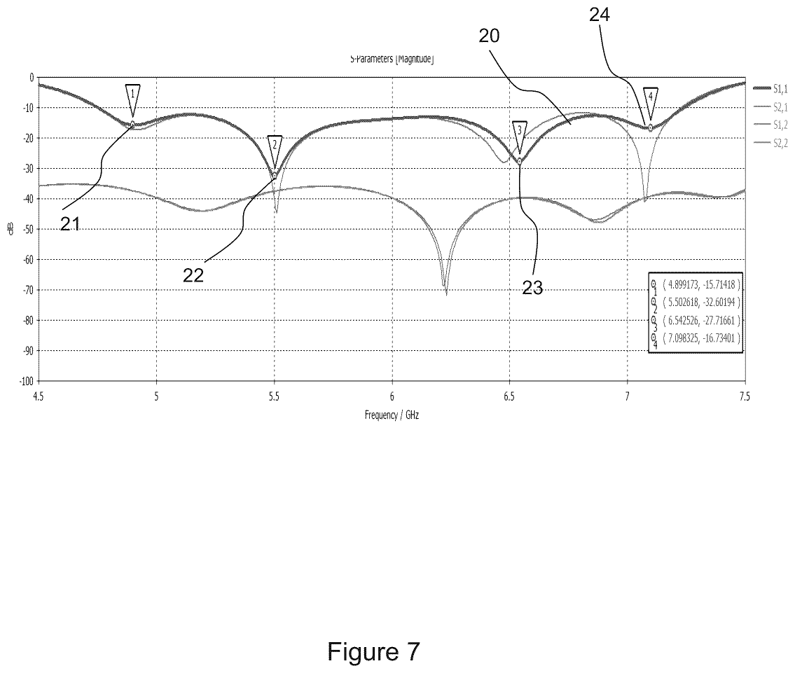

FIG. 7 is a graph showing scattering parameters for the antenna element having three patch radiators as illustrated by FIGS. 5 and 6. In this case the S11 return loss curve 20 shows resonance provided by the slot 21, the resonance provided by the bottom patch 22, the middle patch 23 and the top patch 24.

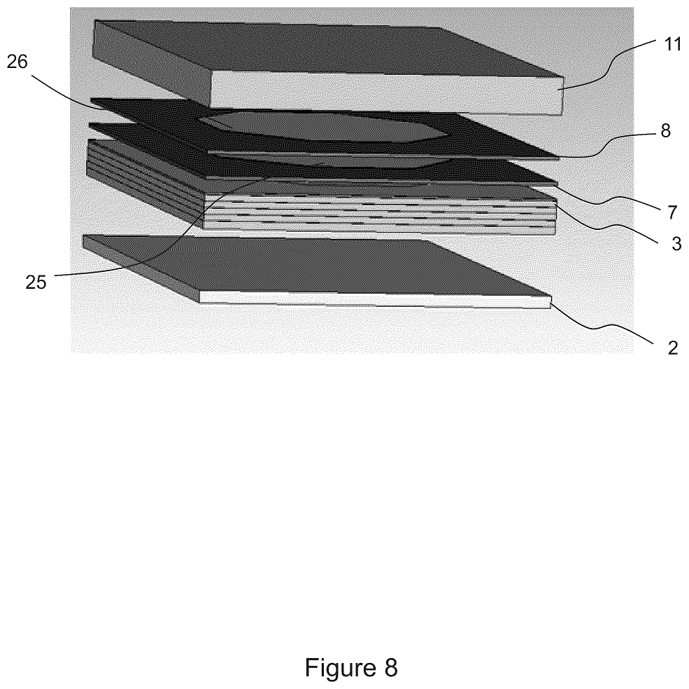

FIG. 8 is an exploded view of an antenna element having octagonal patch radiators, the first 3, second 7, and third 8 planar substrates being formed as layers of a printed circuit board. In the exploded view shown, the planar substrates are shown spaced apart for clarity, but in the example, the substrates are attached to each other as layers of the printed circuit board. The first and second radiator patches 25, 26 are octagonal in shape, in this example. In other examples, the radiator patches may be square or other shapes. In the example of FIG. 8, the spacing between the first planar substrate 3 and the bottom patch 25 is 0.015 wavelengths at an operating frequency of the antenna element, in this case 5 GHz, the spacing between the bottom patch 25 and the top patch is 0.016 wavelengths and the spacing of the non-conductive planar cover from the top patch is 0.05 wavelengths.

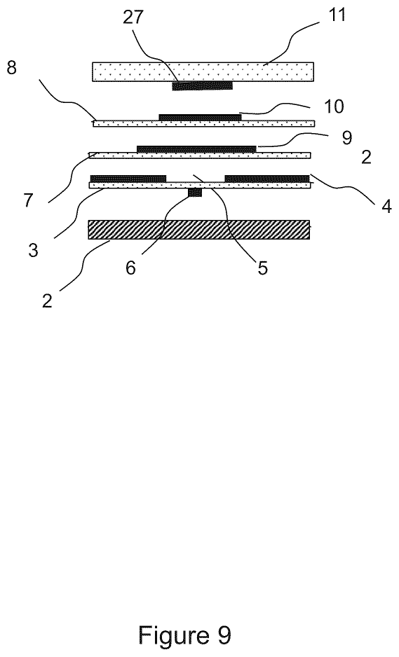

FIG. 9 is schematic diagram illustrating an example in which an antenna element has three patch radiators 9, 10, 27, the top patch radiator 27 being in contact with the non-conductive cover 11. The construction of the antenna element illustrated by FIG. 9 is otherwise similar to that of FIG. 6.

The third radiator patch 27 may be printed on the non-conductive cover, providing for a particularly compact and robust implementation.

The above embodiments are to be understood as illustrative examples of the present disclosure. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What we claim is:

1. An antenna element comprising:
a planar conductive reflector plate;
a first planar substrate carrying a ground plane comprising a slot on a first side, and comprising a feed track on a second side, the feed track being configured to cross the slot;
a plurality of further planar substrates, each carrying a respective radiator patch, each radiator patch having a shape that has same proportions as each other radiator patch and a width which is different from each other radiator patch; and
a planar non-conductive cover,
wherein the planar conductive reflector plate, the first planar substrate, the plurality of further planar substrates, and the planar non-conductive cover are disposed as successive parallel layers,
wherein a separation between successive radiator patches is less than 0.1 wavelengths at an operating frequency of the antenna element and a separation between the radiator patch closest to the planar non-conductive cover and the planar non-conductive cover is less than 0.25 wavelengths at an operating frequency of the antenna element.

2. The antenna element of claim 1, wherein the width of each radiator patch being configured to provide each radiator patch with a different respective resonant frequency within an operating frequency band of the antenna element and wherein the slot is arranged to provide a respective resonant frequency within an operating band of the antenna element, different from the respective resonant frequencies provided by the plurality of radiator patches.

3. The antenna element of claim 2,
wherein the resonant frequency provided by the slot is arranged to be lower than the respective resonant frequencies provided by the plurality of radiator patches.

4. The antenna element of claim 3, wherein a resonant frequency provided by one of the radiator patches is higher than a resonant frequency provided by the slot by a factor of at least 30%.

5. The antenna element of claim 4, wherein a resonant frequency provided by one of the radiator patches is higher than a resonant frequency provided by the slot by a factor of at least 40%.

6. The antenna element of claim 3,
wherein a separation between the planar conductive reflector plate and the first planar substrate is 0.25 wavelengths at the first operating frequency of the antenna element.

7. The antenna element of claim 6,
wherein the slot provides a first resonant frequency and the plurality of further planar substrates comprises a first further planar substrate comprising a first radiator patch providing a second resonant frequency and a second further planar substrate comprising a second radiator patch providing a third resonant frequency, and wherein the width of the first radiator patch at the second resonant frequency is a same proportion of a wavelength as is the width of the second radiator patch at the third resonant frequency.

8. The antenna element of claim 7, wherein the width of the first radiator patch at the second resonant frequency and the width of the second radiator patch at the third resonant frequency is between 0.6 and 0.7 of a wavelength in a dielectric medium of the first further and second further planar substrates.

9. The antenna element of claim 8, wherein the slot has a length of between 0.3 and 0.4 wavelengths in the dielectric medium of the first planar substrate.

10. The antenna element of claim 9, wherein the dielectric medium of the first and second planar substrates has a dielectric constant of 4.2 and the dielectric medium of the first planar substrate has a dielectric constant of 3.5.

11. The antenna element of claim 10, wherein the separation between the first and second radiator patches is 0.05 of a wavelength at the second resonant frequency.

12. The antenna element of claim 11, wherein the second radiator patch is closer to the planar non-conductive cover than is the first radiator patch.

13. The antenna element of claim 12, wherein the separation between the second radiator patch and the planar non-conductive cover is 0.2 of a wavelength at the second resonant frequency.

14. The antenna element of claim 7,
wherein the first, first further, and second further planar substrates are formed as layers of a multi-layer circuit board.

1.5 The antenna element of claim 14, wherein the separation between the first and second radiator patches and the separation between the first radiator patch and the first planar substrate is less than 0.02 of a wavelength at the second resonant frequency.

16. The antenna element of claim 14, wherein the separation between the second radiator patch and the planar non-conductive cover is less than or equal to 0.05 wavelengths at the second resonant frequency.

17. The antenna element of claim 16, wherein the second radiator patch is in contact with the planar non-conductive cover.

18. The antenna element of claim 1,
wherein the plurality of further planar substrates comprises a first, second and third further planar substrate.

19. The antenna element of claim 1,
wherein the shape of each radiator patch is a square.

20. The antenna element of claim 1, wherein the shape of each radiator patch is a hexagon.
